(19) United States
(12) Patent Application Publication
(10) Pub. No.: US 2014/0244764 A1
(43) Pub. Date: Aug. 28, 2014

(54) METHODS, APPARATUS, AND ARTICLES OF MANUFACTURE TO PROVIDE A PROTOCOL-ENABLED INTERFACE DEFINITION LANGUAGE

(71) Applicant: VMWARE, INC., Palo Alto, CA (US)

(72) Inventors: Kristian Helkjær Lassen, Studstrup (DK); Rene W. Schmidt, Risskov (DK)

(73) Assignee: VMWARE, INC., Palo Alto, CA (US)

(21) Appl. No.: 13/780,986

(22) Filed: Feb. 28, 2013

(51) Int. Cl. H04L 29/06

(52) U.S. Cl. CPC H04L 67/40
USPC 709/206

(57) ABSTRACT

Methods and apparatus to provide a protocol-enabled interface definition language are disclosed. An example method includes generating, using a processor, first computer readable instructions to specify a message to be transmitted by a non-initiating device of a transaction for delivery to a second device based on a protocol, and storing, in a storage device, second computer readable instructions to implement the protocol, the second computer readable instructions including the first computer readable instructions.

### FIELD OF THE DISCLOSURE

This disclosure relates generally to computer interfaces and, more particularly, to methods and apparatus to provide a protocol-enabled interface definition language.

### BACKGROUND

Modern computer systems provide interfaces to enable communication. Application programming interfaces (APIs) are used to define the manner in which client applications and server applications can interact. Interface definition languages (IDLs) are used to define the interfaces according to a commonly-understood language.

### BRIEF DESCRIPTION OF THE DRAWINGS

FIG. 1 illustrates an example hierarchy to implement a protocol-enabled interface definition language.

FIG. 2 illustrates an example system to communicate using an interface including a first-class protocol.

FIG. 3 is a block diagram of an example implementation of the example interface generator of FIG. 2.

FIG. 4 illustrates an example system to determine conformance of interface methods with a protocol-enabled interface definition.

FIG. 5 shows pseudocode representative of machine readable instructions to define an interface including first-class protocols.

FIG. 6 shows pseudocode representative of example machine readable instructions to define example messages to be sent for one of the protocols defined in the interface instructions of FIG. 5.

FIG. 7 shows pseudocode representative of example machine readable instructions to define example messages to be sent for one of the protocols defined in the interface instructions of FIG. 5, including an order in which the defined activities are to be performed.

FIG. 8 shows pseudocode representative of example machine readable instructions including an example protocol-enabled interface definition and including an example protocol definition.

FIG. 9A shows pseudocode representative of example machine readable instructions to define an initiating party interface based on the interface definition and the protocol definition defined in the example instructions of FIG. 8.

FIG. 9B shows pseudocode representative of example machine readable instructions to define a non-initiating party interface based on the interface definition and the protocol definition defined in the example instructions of FIG. 8.

FIGS. 10A and 10B show pseudocode representative of example machine readable instructions that may be executed by an initiating device to perform a transaction according to the interface definition and to implement the protocol definition in the example instructions of FIG. 8 based on the initiating party interface of FIG. 9A.

FIGS. 11A and 11B illustrate a flowchart of an example transaction between an initiating device and a non-initiating device according to the interface definition and to implement the protocol definition in the example instructions of FIG. 8.

FIG. 12 shows pseudocode representative of example machine readable instructions to define example messages to be transmitted for one of the protocols defined in the interface of the instructions of FIG. 5, where the messages are defined within the protocol to be invoked by a designated party to a transaction.

FIG. 13 is a flowchart representative of example machine readable instructions to implement the example interface generator of FIGS. 2 and/or 3 to generate an initiating party interface stub.

FIG. 14 is another flowchart representative of example machine readable instructions to implement the example interface generator of FIGS. 2 and/or 3 to generate a non-initiating party interface stub.

FIG. 15 is a flowchart representative of example machine readable instructions to implement the example protocol conformance determiner of FIG. 4 to determine conformance of an interface method with a protocol-enabled interface definition.

FIG. 16 is a flowchart representative of example machine readable instructions to implement the example message runtime of FIG. 1 to determine conformance of an interface method with an interface definition, including a protocol definition, during runtime.

FIG. 17 is a block diagram of an example processing platform capable of executing the instructions of FIGS. 5-10B, 12, and/or 13-16 to implement the interface generator and/or the protocol conformance determiner of FIGS. 2-4.

Wherever possible, the same reference numbers will be used throughout the drawing(s) and accompanying written description to refer to the same or like parts.

### DETAILED DESCRIPTION

Known APIs and IDLs are designed based on request-reply transport mechanisms such as Hypertext Transfer Protocol (HTTP) and/or remote procedure calls (RPC). In request-reply formats, one party (e.g., the client application) sends a request to the other party (e.g., the server application), which processes the request and returns a reply to the client. All communications using the request-reply format originate from one party, and known APIs and IDLs are constrained to this type of communication format.

One problem with request-reply-based APIs is that protocols must build on top of the request-reply vocabulary, which requires that the client drives the protocol and can lead to unnecessarily complicated, unclear, and/or inefficient protocols. For example, in a protocol in which the client must wait for the server to perform a task before the client can continue with a process, the client may be required to repeatedly poll the server, and receive a status in response, until the server returns a status indicating that the client may proceed. Known APIs and IDLs cannot directly define protocols including multiple requests or multiple responses. Additionally, runtime systems implementing known APIs and/or IDLs do not support transactions including multiple requests or multiple responses without highly complicated solutions extending beyond the scope of the API and/or IDL.

In contrast to methods implementing known interface methods and interface definition languages, example methods, apparatus, and articles of manufacture disclosed herein uses a protocol-enabled interface definition language, in which protocols may be defined to permit messages and/or activities to be invoked by any party to a transaction. Relative to known interface definition languages, the protocol-enabled interface definition language disclosed herein increase the speed and efficiency with which interfaces, protocols, and/or transactions can be designed, implemented, and/or performed. For example, example protocol-enabled interface definition languages disclosed herein enable the generation of simpler and/or easier-to-read protocols, thereby increasing the efficiency of implementation.

Example methods, apparatus, and articles of manufacture disclosed herein enable: multi-way communication between multiple parties; explicit description of protocols and/or assignments of tasks (e.g., activities, messages, responsibilities) in terms of roles (e.g., initiating party or client, non-initiating party or server, non-initiating third-party, etc.); and/or explicit definitions of causal dependencies between actions in a protocol. Some example role statements (e.g., source, target, client server, etc.) are disclosed herein. However, example methods, apparatus, and articles of manufacture disclosed herein enable any type(s) of role(s) to be implemented within protocol definitions.

Example methods, apparatus, and articles of manufacture disclosed herein further enable: automatic stub generation to ensure protocol conformance, checking of conformance with the protocol by implementing methods; and/or the use of non-HTTP transport mechanisms (e.g., message queues, WebSockets, etc.) to exchange messages between parties to a transaction. As used herein, the term “stub” refers to automatically generated code, such as code generated by a software development application to assist with software development.

Example methods, apparatus, and articles of manufacture disclosed herein may be used in, for example, a data center to enable the exchange of information between computer systems operating one or more virtual machines. As an example, methods, apparatus, and articles of manufacture disclosed herein enable more efficient migration of virtual machines according to a protocol-enabled interface definition language by enabling a non-initiating device in a transaction (e.g., a physical system receiving a virtual machine being migrated from another physical system) to take initiative and even drive the protocol rather than being restricted to sending responses to requests from the initiating device.

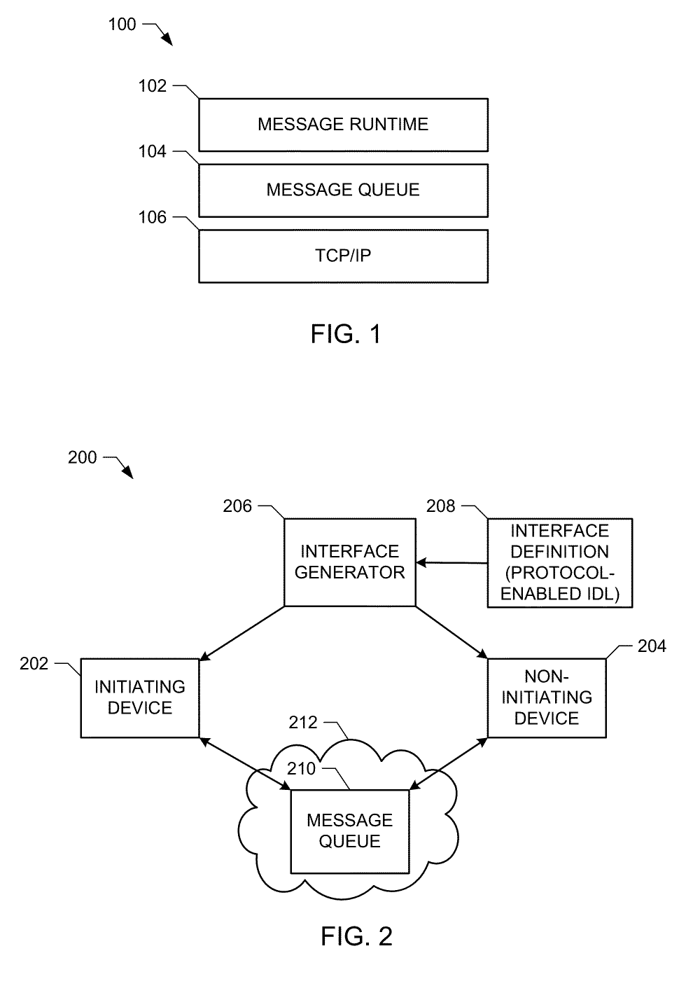

FIG. 1 illustrates an example runtime environment 100 for a protocol-enabled interface definition language. The example runtime environment 100 includes a message runtime 102 that generates, transmits, receives, and/or interprets messages during runtime of a protocol-enabled interface. The example message runtime 102 determines whether the messages being sent and receive conform to the protocol being performed. For example, the message runtime 102 may analyze the message being exchanged to determine whether any messages are sent and/or received out of an order defined by the protocol.

The example message runtime 102 communicates using a message queue 104. A party to the transaction sends messages to another party by transmitting the message to the message queue 104, from where the message may be retrieved by the other party. The example message queue 104 may be implemented using message-queuing-as-a-service providers and/or any other message queuing solution. In some other examples, the parties may communicate using other transport mechanisms such as hypertext transfer protocol (HTTP), simple object access protocol (SOAP), WebSockets, and/or other transport protocols.

The messages transmitted to and/or from the example message queue 104 of FIG. 1 are transported via an Internet protocol (IP) network using transmission control protocol (TCP) 106. Accordingly, the example message queue 104 and the example TCP/IP layer 106 enable parties to a transaction performed via the message runtime 102 to communicate asynchronously and/or remotely.

FIG. 2 illustrates an example system 200 to communicate using an interface including a first-class protocol (e.g., a protocol as a first-class citizen (or first-class entity or first-class object)). As used herein, the term “first-class protocol” refers to a protocol that is an object that does not have restrictions on use. For example, first-class protocols can be dynamically created, destroyed, passed to a function, returned as a value, and have all the rights as other variables. The example system 200 of FIG. 2 includes an initiating device 202 (e.g., a client computing device) and a non-initiating device 204 (e.g., a server), which are parties to an example transaction. The example initiating device 202 initiates the transaction by invoking a shared interface of the non-initiating device 204. The example non-initiating device 204 receives the invocation from the initiating device 202 and proceeds according to a protocol defined within the shared interface. As used herein, a shared interface refers to an interface defined by an interface definition to which both the initiating and non-initiating devices 202, 204 have access.

The example system 200 of FIG. 2 further includes an interface generator 206. The example interface generator 206 of FIG. 2 receives an interface definition 208 based on a protocol-enabled interface definition language. The interface definition 208 may be designed and/or generated by, for example, a software engineer, to achieve a particular task and/or provide a particular service via the non-initiating device 204. In the example of FIG. 2, the interface definition 208 defines a protocol to be performed. The example interface generator 206 of FIG. 2 processes the interface definition 208 to provide the example initiating device 202 and/or the example non-initiating device 204 with a code stub and/or method(s) to invoke the protocol.

When the initiating device 202 and the non-initiating device 204 have implemented the interface and the example protocol according to the interface definition 208, the example initiating device 202 initiates a transaction. In the illustrated example, communication is bilateral. Thus, the example transaction of FIG. 2 may include the initiating device 202 sending messages to and/or invoking actions at the non-initiating device 204. Further, the example transaction of FIG. 2 may also include the non-initiating device 204 sending messages to and/or invoking actions at the initiating device 202. Sending messages between the example devices 202, 204 of FIG. 2 is performed using a message queue 210. In some examples, one or more messages may be directly exchanged between the parties. For example, the initiating device 202 may initiate the protocol via a remote procedure call (RPC) to the non-initiating device 204.

The example message queue 210 receives messages from the initiating device 202 and stores the messages until they are retrieved by the non-initiating device 204. Similarly, the example message queue 210 receives messages from the non-initiating device 204 and stores the messages until they are retrieved by the initiating device 202. Thus, the example initiating device 202 and/or the example non-initiating device 204 may exchange messages asynchronously by queuing the messages in the message queue 210. In the example of FIG. 2, the message queue 210 is implemented as a service located on an IP network 212 such as the Internet.

In some examples, the initiating device 202 and/or the non-initiating device 204 may be implemented using state-machines or similar methods to enable asynchronous transmission and/or receiving of messages. An example state machine implementation of the initiating device 202 and/or the non-initiating device 204 may include initiating a loop of instructions which transmit messages in response to conditions and/or handle received messages when detected.

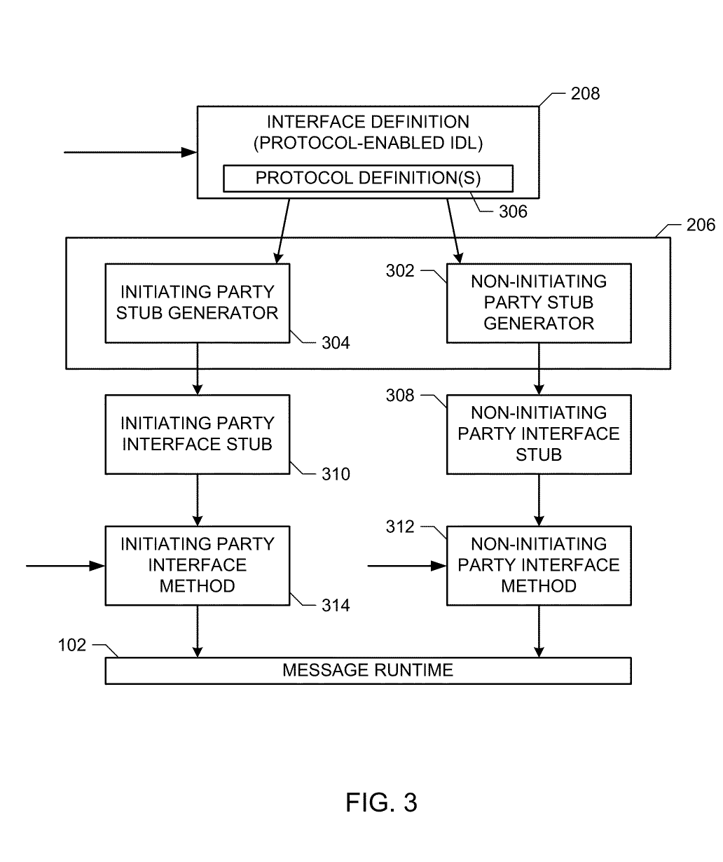

FIG. 3 is a block diagram of an example implementation of the example interface generator 206 of FIG. 2. The example interface generator 206 of FIG. 3 receives an interface definition 208 defining a protocol and generates machine readable instructions and/or human readable code to enable the parties to an interface based on the interface definition 208 to implement the interface and/or the protocol.

The example interface generator 206 of FIG. 3 includes a non-initiating party stub generator 302 and an initiating party stub generator 304. The example stub generators 302, 304 parse the interface definition 208 and a protocol definition 306 included in the interface definition 208. Based on the interface definition 208, the example non-initiating party stub generator 302 generates a non-initiating party stub 308 to implement the protocol definition 306. Similarly, the example initiating party stub generator 304 generates an initiating party stub 310 to implement the protocol definition 306 based on the interface definition 208. The example non-initiating party stub 308 and the example initiating party stub 310 implement different sides of a transaction based on the protocol definitions 306, which define the message(s) and/or activities sent and/or invoked by each of the parties to the transaction.

The example non-initiating party stub 308 may be modified to further define the actions to be taken by the example non-initiating device 204 to generate a non-initiating party interface method 312. The example non-initiating party interface method 312 of FIG. 3 includes machine readable instructions and/or human-readable code that defines the activit(ies) to be performed by the non-initiating device 204, the message(s) to be received by the non-initiating device 204, and/or the message(s) to be sent by the non-initiating device 204. In some examples, the non-initiating party interface method 312 further includes causal dependencies between activities, transmitted message(s), and/or received message(s) to conform to the protocol definition(s) 306. The example interface methods 312, 314 of FIG. 3 may be provided to the message runtime 102 of FIG. 1, which executes the interface methods 312, 314 and/or performs runtime protocol conformance analysis on the interface methods 312, 314.

The example initiating party stub 310 of FIG. 3 may be modified to further define the actions to be taken by the example initiating device 202 to generate an initiating party interface method 314. The example initiating party interface method 314 of FIG. 3 includes machine readable instructions and/or human-readable code that define the activit(ies) to be performed by the initiating device 202, the message(s) to be received by the initiating device 202, and/or the message(s) to be sent by the initiating device 202. In some examples, the non-initiating party interface method 314 further includes causal dependencies between activities, transmitted message(s), and/or received message(s) to conform to the protocol definition(s) 306. In some example protocols, the non-initiating party interface method 312 and the initiating party interface method 314 are implemented symmetrically, where messages transmitted via the non-initiating party interface method 312 are received via the initiating party interface method 314 and vice versa. In some examples, activities or tasks are invoked by the non-initiating party interface method 312 and performed via the initiating party interface method 314, and vice versa.

As with other IDLs and protocols, interfaces and/or protocols defined using the example protocol-enabled IDL used in the examples of FIGS. 2 and 3 are defined at least partially via human input. However, unlike known IDLs and protocols, the example interface generator 206 of FIGS. 2 and/or 3 generates non-initiating party stubs and/or initiating party stubs based on the responsibilities of each party performing the protocol during a transaction that are defined in the protocol definition 306 and are not necessarily dependent on a request-response format.

While an example manner of implementing the interface generator 206 of FIG. 2 has been illustrated in FIG. 3, one or more of the elements, processes and/or devices illustrated in FIG. 3 may be combined, divided, re-arranged, omitted, eliminated and/or implemented in any other way. Further, the example non-initiating party stub generator 302, the example initiating party interface stub generator 304 and/or, more generally, the example interface generator 206 of FIGS. 2 and/or 3 may be implemented by hardware, software, firmware and/or any combination of hardware, software and/or firmware. Thus, for example, any of the example non-initiating party stub generator 302, the example initiating party interface stub generator 304 and/or, more generally, the example interface generator 206 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the apparatus or system claims of this patent are read to cover a purely software and/or firmware implementation, at least one of the example non-initiating party stub generator 302 and/or the example initiating party interface stub generator 304 are hereby expressly defined to include a tangible computer readable medium such as a memory, DVD, CD, Blu-ray, etc. storing the software and/or firmware. Further still, the example interface generator 206 of FIGS. 2 and/or 3 may include one or more elements, processes and/or devices in addition to, or instead of, those illustrated in FIG. 3, and/or may include more than one of any or all of the illustrated elements, processes and devices.

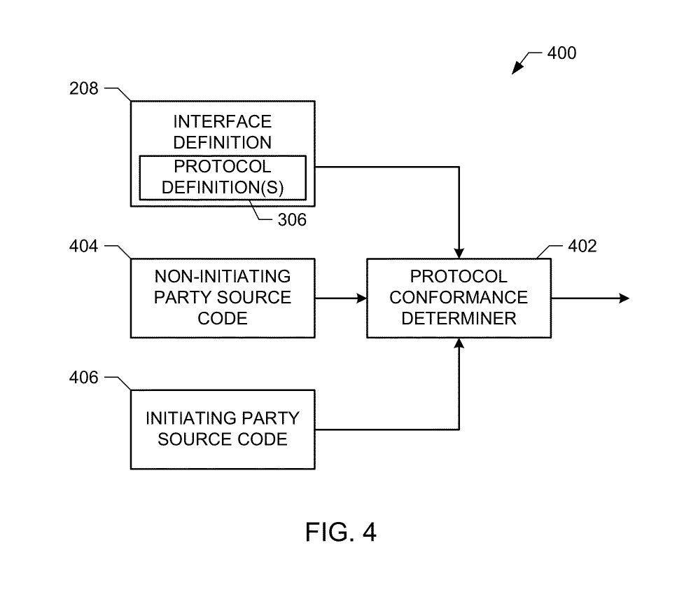

FIG. 4 illustrates an example system 400 to determine conformance of interface methods with a protocol-enabled interface definition (e.g., the protocol-enabled interface definition 208 of FIGS. 2 and/or 3 including the protocol definition(s) 306 of FIG. 3). The example system 400 of FIG. 4 may be used when, for example, the protocol definition 306 specifies causal dependencies within the protocol (e.g., a subsequent action cannot be performed by the initiating or non-initiating party or device until a prior action occurs).

The example system 400 of FIG. 4 includes a protocol conformance determiner 402 to determine whether a non-initiating party source code 404 (e.g., the source code defining behavior or implementation of the non-initiating party 204 with respect to the protocol definition 306) and/or initiating party source code (e.g., the source code defining the behavior or implementation of the initiating party 202 with respect to the protocol definition 306) conform to a protocol definition 306 included in the protocol-enabled interface definition 208. In some examples, the protocol conformance determiner 402 is implemented in a compiler program that analyzes source code and generates warnings and/or errors during analysis of the non-initiating party interface method 312 and/or the initiating party interface method 314 if any causal dependencies are violated. In the example of FIG. 4, the protocol conformance determiner 402 determines static conformance of the non-initiating party source code 404 and/or the initiating party source code 406 to the protocol and does not perform runtime analysis (e.g., the runtime analysis performed via the message runtime 102 of FIG. 1). In some examples, the protocol conformance determiner 402 analyzes the non-initiating party source code 404 or the initiating party source code 406 individually.

For example, the protocol conformance determiner 402 of the illustrated example may receive the interface definition 208 and determine causal dependencies present in the protocol definitions 306. The example protocol conformance determiner 402 further receives the non-initiating party source code 404 (e.g., a set of instructions modified from the non-initiating party interface stub 308 of FIG. 3 by a person) and analyzes the source code 404 to determine whether any of the specified causal dependencies are violated by the source code 404. Similarly, the example protocol conformance determiner 402 of the illustrated example receives the initiating party source code 406 (e.g., a set of instructions modified from the non-initiating party interface stub 310 of FIG. 3 by a person) and analyzes the source code 406 to determine whether any of the specified causal dependencies are violated by the source code 406.

To determine whether dependencies are violated, the example protocol conformance determiner 402 may trace (e.g., execute or simulate execution and follow the execution of) the non-initiating party source code 404 and/or the initiating party source code 406 to determine whether a defined protocol dependency is violated under one or more sets of inputs to the source code 404, 406.

While runtime analysis may be simpler and can check more protocols and/or code paths of the source code 404, 406, static conformance analysis performed by the example protocol conformance determiner 402 can identify protocol non-conformance earlier. However, the static conformance analysis performed by the example protocol conformance determiner 402 may falsely identify some conformance errors. In static analysis, the example protocol conformance determiner 402 deduces the possible code paths based on application structure and independent of possible inputs. Thus, the set of code paths considered by the protocol conformance determiner 402 may be greater than the code paths actually taken at runtime. In those cases, the example protocol conformance determiner 402 may report false instances of non-conformance of the source code 404, 406 under analysis. While these false instances are cases that do not occur during execution of the source code 404, 406, based on the knowledge available to the protocol conformance determiner 402, the instances are reported.

The example protocol conformance determiner 402 of FIG. 4 outputs a report detailing any violations of the protocol or, if the source code 404, 406 conforms to the protocol, an indication of the conformance. The report may be analyzed by the code developer to address any violations of the protocol that could occur during runtime.

While an example manner of implementing the system 400 has been illustrated in FIG. 4, one or more of the elements, processes and/or devices illustrated in FIG. 4 may be combined, divided, re-arranged, omitted, eliminated and/or implemented in any other way. Further, the example protocol conformance checker 402 of FIG. 4 may be implemented by hardware, software, firmware and/or any combination of hardware, software and/or firmware. Thus, for example, any the example protocol conformance checker 402 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the apparatus or system claims of this patent are read to cover a purely software and/or firmware implementation, the example protocol conformance checker 402 of FIG. 4 is hereby expressly defined to include a tangible computer readable medium such as a memory, DVD, CD, Blu-ray, etc. storing the software and/or firmware. Further still, the example protocol conformance checker 402 of FIG. 4 may include one or more elements, processes and/or devices in addition to, or instead of, those illustrated in FIG. 4, and/or may include more than one of any or all of the illustrated elements, processes and devices.

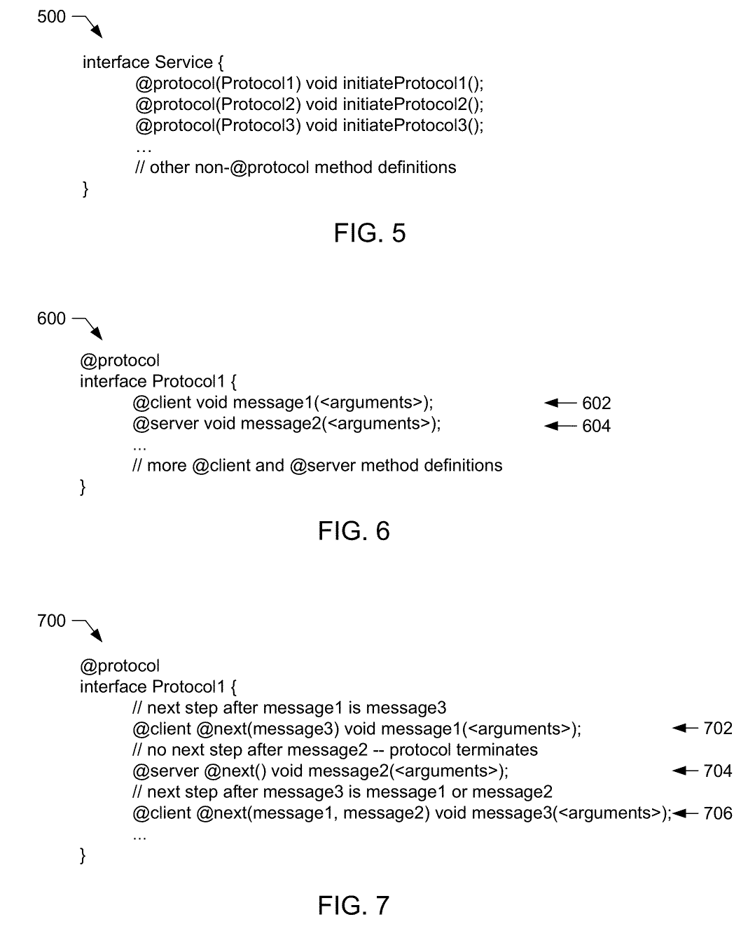

FIG. 5 shows pseudocode representative of example machine readable instructions 500 to define an interface including first-class protocols (e.g., protocols as first-class objects, entities, or citizens). The example instructions 500 of FIG. 5 may implement the example interface definition 208 of FIGS. 2 and/or 3. The example instructions 500 define the name of the interface (e.g., Service) and declare the protocols (e.g., Protocol1, Protocol2, Protocol3). The example @protocol statement indicates that the protocol is a first-class entity and will be used in method names. An invocation of an annotated method corresponding to the @protocol statement initiates the corresponding protocol.

In the example instructions of FIG. 5, each @protocol method describes a protocol initiation. Invoking the method (e.g., invoking initiateProtocol1( ) via the initiating device 202 of FIG. 2) includes allocating a new instance of the protocol interface denoted by the protocol name (e.g., Protocol1) and redirecting communications between the parties to that instance (e.g., the parties 202, 204 of FIG. 2) until the protocol has completed.

FIG. 6 shows pseudocode representative of example machine readable instructions 600 to define example messages to be sent for one of the protocols (e.g., @protocol Protocol 1) defined in the interface instructions 500 of FIG. 5.

The example pseudocode of FIG. 6 defines messages 602, 604 that are part of the protocol Protocoll. The definitions of the example message 602, 604 specify which of the parties to a transaction is responsible for sending the message (e.g., @client, @server), the name of the message (e.g., message1, message2) that corresponds to an action in the protocol Protocol1, and any arguments that are part of the protocol action. As used herein, the term “client” may refer to an initiating party of a transaction and the term “server” may refer to a non-initiating party of a transaction, to conform to naming conventions for defining transactions.

To implement the example instructions 600 of FIG. 6, the example initiating device 202 sends message1 and the non-initiating device 204 sends message2. The example non-initiating party stub generator 302 of FIG. 3, on receiving the protocol definition 306 including the instructions 600, determines that the message2 message 604 is to be transmitted or invoked and the message1 message 602 is to be received by the non-initiating device 204 of FIG. 2. Thus, the example non-initiating party stub generator 302 generates the non-initiating party interface stub 308 to define the example message2 message 604 of FIG. 6 as a subroutine having no return arguments. The example non-initiating party stub generator 302 defines the message1 message 602 as a variable. The variable is generated to have a type based on the arguments of the message1 message 602 and to have a value to be determined based on the contents of the received message1 during runtime.

The example initiating party stub generator 304 of FIG. 3, on receiving the protocol definition 306 including the instructions 600, determines that the message1 message 602 is to be transmitted or invoked by the initiating device 202 of FIG. 2. The example initiating party stub generator 304 further determines that the message2 message 604 is to be received by the initiating device 202. Accordingly, the example non-initiating party stub generator 302 generates the initiating party interface stub 308 to define the example message1 message 602 of FIG. 6 as a subroutine having no return arguments. The example non-initiating party stub generator 302 generates the initiating party interface stub 308 to define the message2 message 604 as a variable. The variable is generated to have a type based on the arguments of the message2 message 604 and to have a value to be determined based on the contents of the received message2 during runtime.

FIG. 7 shows pseudocode representative of example machine readable instructions 700 to define example messages to be sent for one of the protocols defined in the interface instructions 500 of FIG. 5. The example instructions 700 of FIG. 7 may implement the example protocol definition 306 of FIG. 3, and further includes an order in which the defined messages are to be transmitted.

The example instructions 700 of FIG. 7 define messages 702, 704, 706 to be exchanged as part of protocol Protocoll. The example messages 702-706 each include a @next statement to enable the definition of a causal dependency for each of the messages 702-706. For example, the instructions 700 define a first message 702 to be sent by a client or initiating party and to include one or more arguments. The example instructions 700 further specify that, to comply with the protocol, the message 702 is to be followed by a message3 message 706. Thus, if the example initiating device 202 of FIG. 2 sends a message1 message, and a message other than a message3 message is sent as a next message, the example protocol defined in the instructions 700 is broken.

The example instructions 700 define the second message 704 to be sent by the server or non-initiating party. According to the protocol defined by the instructions 700, the example second message 704 is not followed by any other messages and, thus, the protocol terminates after a message2 message is sent by the non-initiating party.

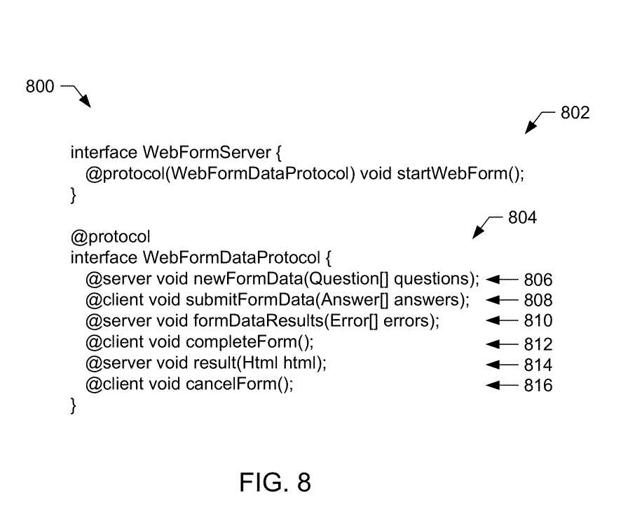

FIG. 8 shows pseudocode representative of example machine readable instructions 800 including an example interface definition 802 and including an example protocol definition 804. The example instructions 800 may be converted by the example interface generator 206 of FIGS. 2 and/or 3 into a non-initiating device stub (e.g., the non-initiating party interface stub 308 of FIG. 3) and an initiating device stub (e.g., the initiating party interface stub 310 of FIG. 3) to enable the initiating device 202 and the non-initiating device 204 of FIG. 2 to communicate according to the protocol definition 804. The example instructions 800 define an example interface that a server may expose to a client to enable the client to receive a web form including requests for information to be provided by a user, to provide responses to the requests, and/or to receive a web page.

The example interface definition 802 of FIG. 8 may implement the example interface definition 208 of FIGS. 2 and/or 3, and specifies the first-class protocol WebFormDataProtocol is initiated by an initiating device calling a startWebForm( )method.

The example protocol definition 804 of FIG. 8 may implement the example protocol definition 306 of FIG. 3, and specifies several messages 806-816 that may be exchanged between an initiating party and a non-initiating party. The example messages 806, 810, 814 are defined to be sent by a server (e.g., a non-initiating party) and the example messages 808, 812, 816 are defined to be sent by a client (e.g., an initiating party).

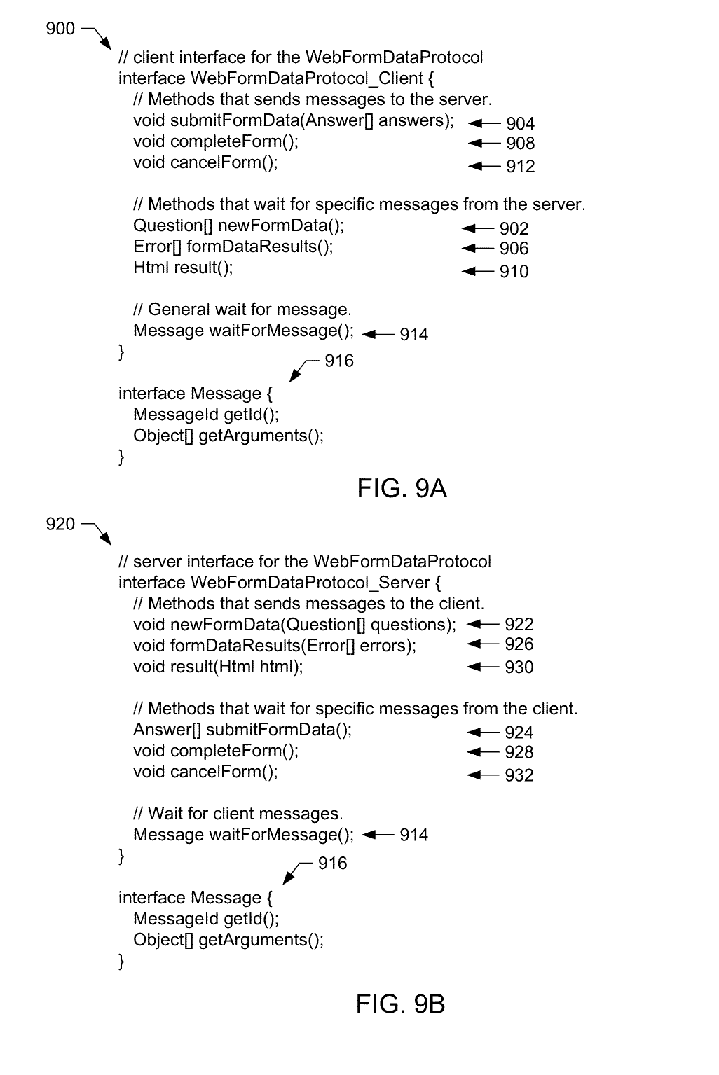

FIG. 9A shows pseudocode representative of example machine readable instructions 900 to define an initiating party interface based on the interface definition 802 and the protocol definition 804 defined in the example instructions 800 of FIG. 8. The example instructions 900 may be generated by the example initiating party stub generator 304 and may implement the example initiating party interface stub 310 of FIG. 3 by processing (e.g., compiling) the instructions 800 of FIG. 8 (e.g., the interface definition 208 and/or the protocol definition 306 of FIGS. 2 and/or 3).

The example instructions 900 include statements 902-912 corresponding to the example messages 806-816 of FIG. 8. For example, the initiating party stub generator 304 may parse the example message 806 to determine that the corresponding initiating party construct 902 is to handle the receipt of a message from a non-initiating party, which includes storing and/or processing an input (e.g., a Question[ ] array). The example initiating party stub generator 304 also parses the example messages 810, 814 of FIG. 8 to generate corresponding constructs 906, 910. The example constructs 902, 906, 910 return an object (e.g., an array, a string, etc.) corresponding to the type of message received from the non-initiating party.

The example initiating party stub generator 304 parses the example message 808 of FIG. 8 to generate a method or procedure 904, including declaring corresponding arguments (e.g., Answer[ ] answers). The example initiating party stub generator 304 also generates methods 908, 912 based on the corresponding messages 812, 816 defined in the protocol definition 804. The example initiating party stub generator 304 outputs the example instructions 900 of FIG. 9A as an initiating party interface stub 310.

The example initiating party stub generator 304 further generates a method or procedure 914 for the initiating party to wait for messages from the non-initiating party. The example procedure 914 is defined in a Message interface 916. The example waitForMessage method 914 causes an initiating device to wait for any message. In contrast, the example methods newFormData 902, formDataResults 906, and result 910 cause the initiating device to wait for a specific message (e.g., a message having a particular message Id). For example, when the initiating device 202 calls newFormData 902, the initiating device 202 may also call waitForMessage 914. According to the example protocol, the received message should contain an Id field of “newFormData” and an arguments field including the Question[ ] array. The example initiating device 202 may use a message-specific method (e.g., newFormData 902, formDataResults 906, etc.) and the general waitForMessage makes it possible for the client to explicitly validate whether it is the right message. If the protocol allows for different messages at the same point in the protocol, waitForMessage 914 is used from the client to wait for one of multiple (or any) incoming messages.

An explicit call to newFormData 902 should fail (e.g., throw a runtime exception) if any other message than a message having an Id of “newFormData” and a value of “Question[ ]” is received. A call to waitForMessage 914 may fail (e.g., throw a runtime exception) if a message has an Id that is not a valid message defined within the protocol is received. In the example of FIG. 9A, a call to waitForMessage 914 fails if the message Id is not “newFormData,” “formDataResults,” or “result.” If successful, the waitForMessage method 914 returns a value including a message Id (e.g., newFormData, formDataResult, etc.), and argument(s) associated with the messages identified by the Id. For example, the message related to newFormData has an argument Question[ ], and the message related to formDataResult has an argument Error[ ].

FIG. 9B shows pseudocode representative of example machine readable instructions 920 to define a non-initiating party interface based on the interface definition 802 and the protocol definition 804 defined in the example instructions 800 of FIG. 8. The example instructions 920 may be generated by the example non-initiating party stub generator 302 and may implement the example non-initiating party interface stub 308 of FIG. 3 by processing (e.g., compiling) the instructions 800 of FIG. 8 (e.g., the interface definition 208 and/or the protocol definition 306 of FIGS. 2 and/or 3). The example instructions 920 of FIG. 9B are generated to be symmetrical to the example instructions 900 of FIG. 9A (e.g., to implement the opposing party to a transaction involving the instructions 900).

The example instructions 920 include statements 922-932 corresponding to the example messages 806-816 of FIG. 8. For example, the non-initiating party stub generator 302 may parse the example message 806 to determine that the corresponding non-initiating party construct 922 transmits a message from the non-initiating party, which includes transmitting an argument (e.g., a Question[ ] array). The example initiating party stub generator 304 also parses the example messages 810, 814 of FIG. 8 to generate corresponding constructs 926, 930. The example constructs 924, 928, 932 return an object (e.g., an array, a string, etc.) or do not return any objects (e.g., void) corresponding to the type of message received from the non-initiating party.

The example non-initiating party stub generator 302 parses the example message 808 of FIG. 8 to generate a method or procedure 924, including handling corresponding arguments (e.g., Answer[ ] answers). The example initiating party stub generator 304 also generates methods 928, 932 based on the corresponding messages 812, 816 defined in the protocol definition 804. The example non-initiating party stub generator 304 outputs the example instructions 900 of FIG. 9A as a non-initiating party interface stub 309.

The example non-initiating party stub generator 302 further generates a Message method 914 and a corresponding interface 916. The example Message method 914 and the interface 916 to implement the Message method 914 are substantially identical to the example method 914 and interface 916 of FIG. 9A and, thus, are not further discussed to avoid redundant description.

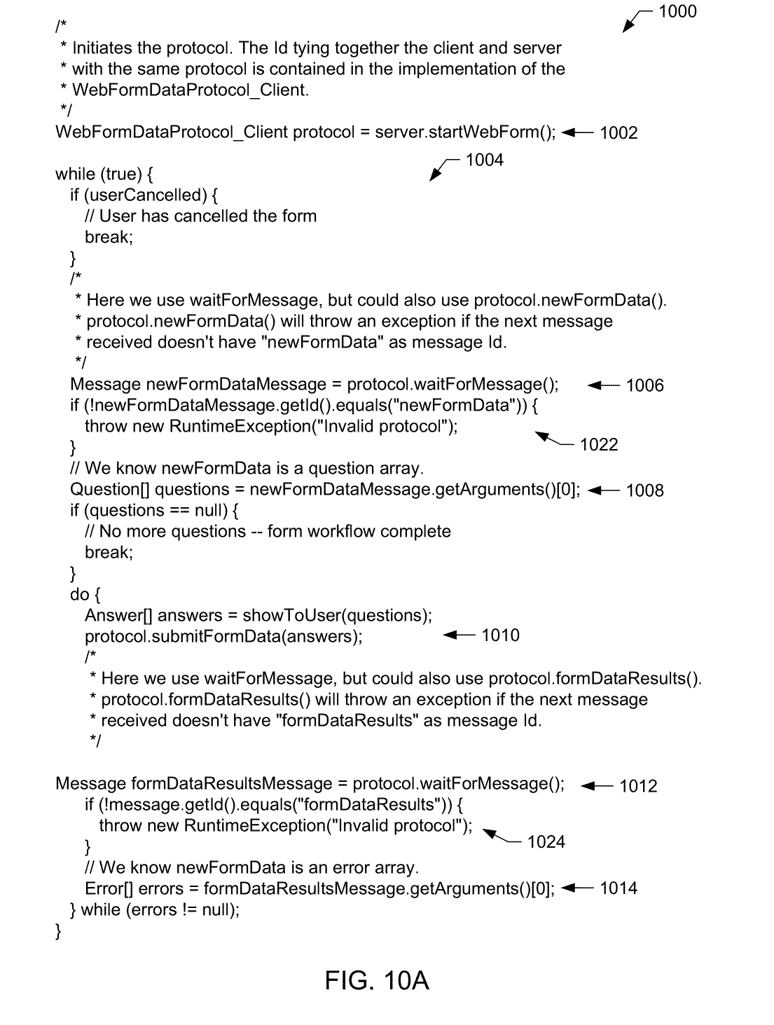

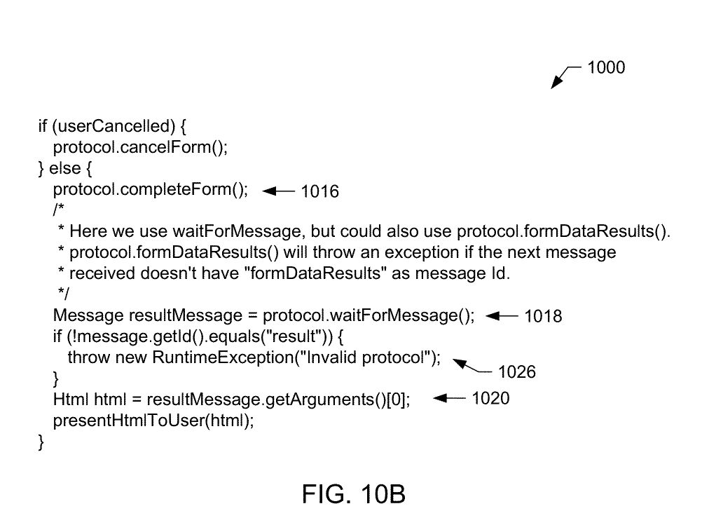

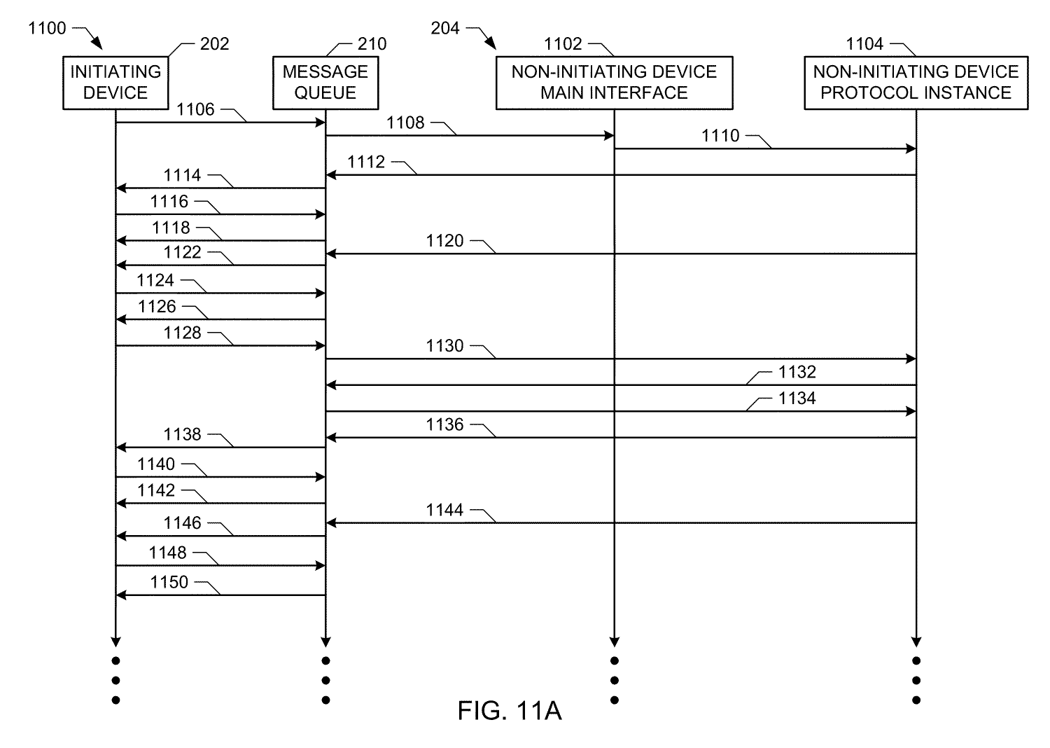

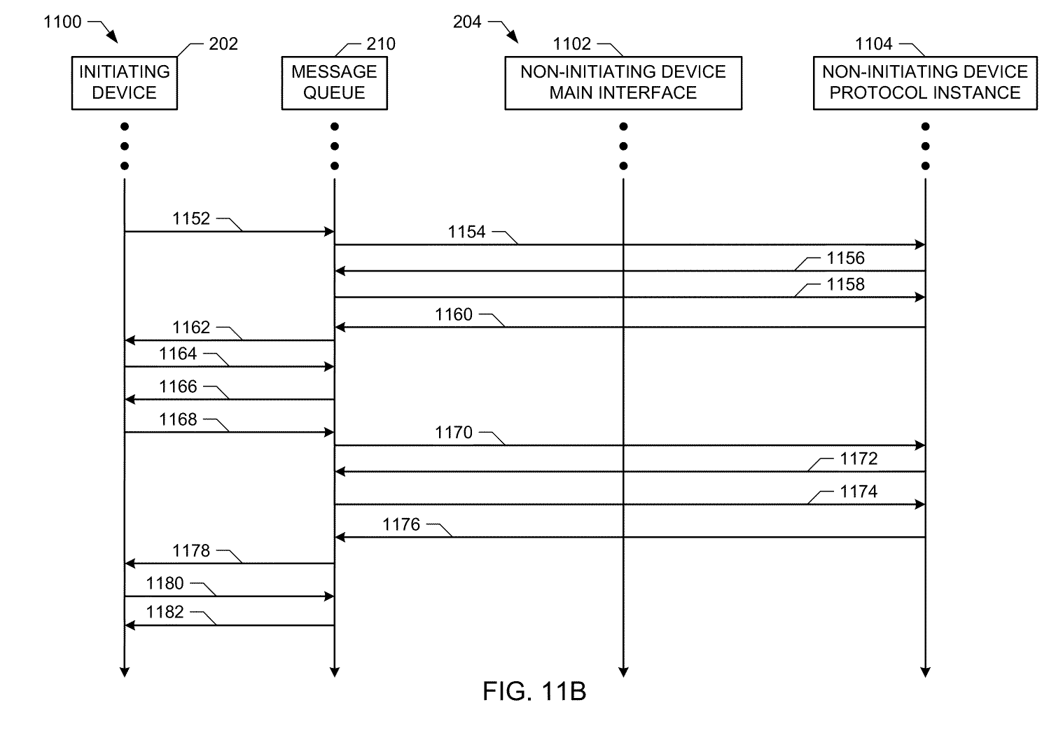

FIGS. 10A and 10B collectively show pseudocode representative of example machine readable instructions 1000 that may be executed by an initiating device to perform a transaction according to the interface definition 802 and to implement the protocol definition 804 in the example instructions 800 of FIG. 8 based on the initiating party interface of FIG. 9A. FIGS. 11A and 11B collectively illustrate a flowchart of an example transaction 1100 between an initiating device and a non-initiating device according to the interface definition 802. In the example transaction 1100 between the example initiating device 202 and the example non-initiating device 204 of FIG. 2 may implement the protocol definition 804 in the example instructions 800 of FIG. 8. The example instructions 1000 of FIGS. 10A and 10B may implement the example initiating party interface method 314 of FIG. 3 and/or may be executed by the initiating device 202 to participate in the example transaction 1100 of FIGS. 11A and 11B.

The example instructions 1000 may be based on a stub represented by the example instructions 900 of FIG. 9A. Execution of the example instructions 1000 of FIGS. 10A and 10B and execution of a protocol defined in the protocol definition 804 of FIG. 8 are described below with reference to the example system 200 of FIG. 2.

In the example of FIGS. 11A and 11B, the non-initiating party 204 includes a main interface 1102 and instantiates a protocol instance 1104. The example instructions 1002 enable the initiating device 202 of FIG. 2 to initiate the instance 1104 of the protocol WebFormDataProtocol. For example, the initiating device 202 may transmit a message 1106 (e.g., messageId=“startWebForm”, args=[ ], protocolId=<unset>) via the message queue. The example message queue 210 delivers the message 1108 to the non-initiating party main interface 1102.

When the instruction 1002 is invoked, the example initiating device 202 invokes the interface WebFormServer and/or protocol WebFormDataProtocol defined in the instructions 800 of FIG. 8. On receiving the initiating message 1108 (e.g., via requesting or retrieving the message 1108 from the message queue 210), the example non-initiating device 204 allocates or instantiates the protocol 1110 and provides the protocol instance 1104 with an identifier (e.g., protocol “id456”). The example protocol instance 1104 sends a message 1112 (e.g., messageId=“WebFormDataProtocol”, args=[ ], protocolId=“id456”) to the example message queue 210, which transmits a message 1114 identifying the message 1112 to the example initiating device 202. Based on receiving the message 1114, the example initiating device 202 requests (e.g., consume 1116) and receives 1118 the message 1112 including the identifier of the protocol instance 1104.

The example initiating device 202 enters a loop 1004 to handle messages from the non-initiating device 204 such as the newFormData message 806, to return messages to the non-initiating device 204 such as the submitFormData message 808, and to handle any result messages from the non-initiating device 204 such as the formDataResults message 810. For example, the instruction 1006 causes the initiating device 202 to wait for a message from the non-initiating device 204. When the non-initiating device 204 transmits a message (e.g., a messageId=“newFormData”, args=[questions], protocolId=“id456” message 1120, 1144 via the message queue 210 of FIG. 11A), the example initiating device 202 receives a message 1122, 1146 to notify the initiating device 202 of the message 1120, 1144. The example initiating device 202 executes an instruction 1008 to retrieve (e.g., consume 1124, 1148) the message 1120, 1144 from the message queue 210. The example message queue 210 then transmits 1126, 1150 the message 1120, 1144 to the initiating device 202.

Based on the message from the non-initiating device 204, the example initiating device 202 displays the question to the user (e.g., via a user interface of the initiating device 202). The example initiating device 202 executes an instruction 1010 to transmit a message 1128, 1152 (e.g., a messageId=“submitFormData”, args=[answers], protocolId=“id456”), including the response data (e.g., answers), to the protocol instance 1104 via the message queue 210. The example non-initiating device 204 is notified via a message 1130, 1154, requests (e.g., consumes 1132, 1156, and receives 1134, 1158, the message 1128, 1152 including the response data.

The example initiating device 202 executes an instruction 1012 to wait for a message from the non-initiating device 204. The example non-initiating device 204 transmits a message 1136, 1160 (e.g., a messageId=“dataFormResults”, args=[errors], protocolId=“id456”). The example message queue 210 notifies 1138, 1162 the initiating device 202 of the message 1136, 1160. The example initiating device 202 executes an instruction 1014 to retrieve (e.g., consume 1140, 1164) the message from the message queue 210 and receives 1142, 1166 the message 1136, 1160 from the message queue 210.

Continuing with the example instructions 1000 in FIG. 10B, when the example initiating device 202 finishes the loop 1004 (e.g., no further questions and/or answers are to be exchanged), and the protocol has not been canceled by a user, the example initiating device 202 executes an instruction 1016 to send a message 1168 (e.g., messageId=“completeFormData”, args=[ ], protocolId=“id456”, the defined message 812 of FIG. 8) to signal to the non-initiating device 204 that the data submission is completed. The example non-initiating device 204 is notified 1170 the completeFormData message 1168, requests (e.g., consume 1172) and receives 1174 the example message 1168 via the message queue 210.

The example non-initiating device 204 sends, and the initiating device 202 receives via instruction 1018, a result message 1176 (e.g., a messageId=“result”, args=[html], protocolId=“id456”, the defined message 814 of FIG. 8) including an html value via the message queue 210. In the examples of FIGS. 10A, 10B, 11A, and 11B, the html value may be one or more strings defining an HTML document (e.g., for display as a web page). The example initiating device 202 receives a message 1178 identifying the message 1176. The example initiating device 202 executes an instruction 1020 to request (e.g., consume 1180) and receive 1182 the example message 1176 via the message queue 210. The example initiating device 202 may present the resulting HTML document to a user (e.g., via a user interface).

The example instructions 1000 of FIGS. 10A and 10B include protocol conformance checking instructions 1022, 1024, 1026 to enable the message runtime 102 of FIG. 1 to determine whether the example interface method represented by the instructions 1000 conforms to an underlying protocol (e.g., the protocol definition 306 of FIG. 3). The example instructions 1022-1026, upon receiving a message via instructions 1006, 1012, 1018, determine whether the received message is the message that is to be received based on the protocol definition 306. If the received message is not expected at the time it is received, the example instructions 1022-1026 throw an exception to be handled by the message runtime 102 (e.g., issuing an error, ending the protocol, etc.).

In contrast with known interface implementations, the example instructions 1000 of FIGS. 10A and 10B enable the non-initiating device 204 to asynchronously send information (e.g., the newFormData message) without waiting for it to be requested by the initiating device 202. Thus, the example non-initiating device 204 may send sequential messages without being repeatedly polled for information by the example initiating device 202. For example, the non-initiating device 204 transmits multiple messages 1112 and 1120, 1136 and 1144 in sequence and without the initiating device 202 requesting the information corresponding to the messages 1120 and 1144. Such an example enables the non-initiating device 204 to control all or part of a protocol, rather than relying on the initiating device 202 to control the entire protocol. While the requests to retrieve data from the message queue 210 may be performed in request-response format, such requests are independent of the transmission of the message from the non-initiating device 204 and do not block further execution by either device 202, 204 as in a request-response format.

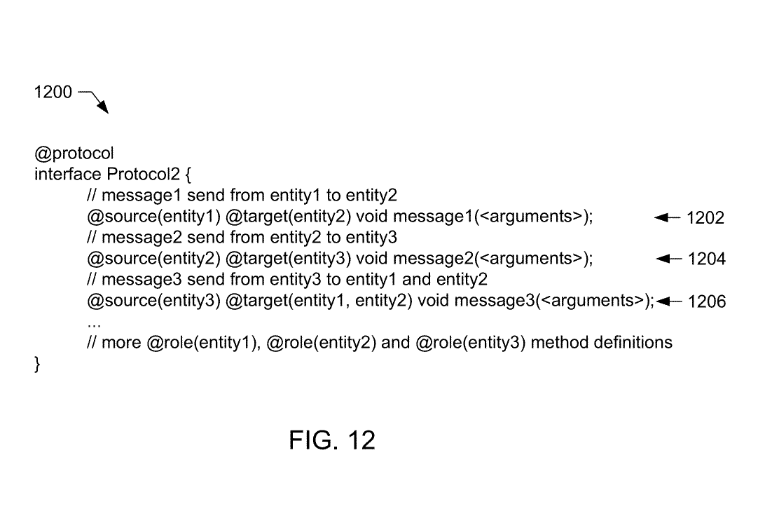

FIG. 12 shows pseudocode representative of example machine readable instructions 1200 to define example messages to be transmitted for one of the protocols defined in the interface of the instructions 500 of FIG. 5. The example instructions 1200 of FIG. 12 may implement the example protocol definition 306 of FIG. 3. In the example instructions 1200 of FIG. 12, messages 1202-1206 are defined within the protocol (e.g., Protocol2) to be targeted or sent to a designated party to a transaction.

The example messages 1202-1206 of FIG. 12 include a @source statement to specify a party to a transaction that is to transmit the message 1202-1206 and a @target statement to specify a party to the transaction that is to receive the message 1202-1206. In the example of FIG. 12, each message 1202-1206 may be sent by one source device and may be targeted to one or more target devices. The example messages 1202-1206 further specify the name of the message 1202-1206 and any arguments.

The example message 1202 of FIG. 12 is to be transmitted by a first entity or device entity1 to a second entity or device entity 2. The example message 1204 is to be transmitted by the second entity entity2 to a third entity or device entity3. The example message 1206 is to be transmitted by the third entity entity3 to the first and second entities entity1, entity2.

The example @source and @target role statements are advantageously used with protocols involving more than two parties (e.g., devices). The example @source and @target roles illustrated in FIG. 12 may be combined with the @next statements of FIG. 7 to further specify protocols and interfaces using the protocol-enabled interface definition language of the illustrated examples.

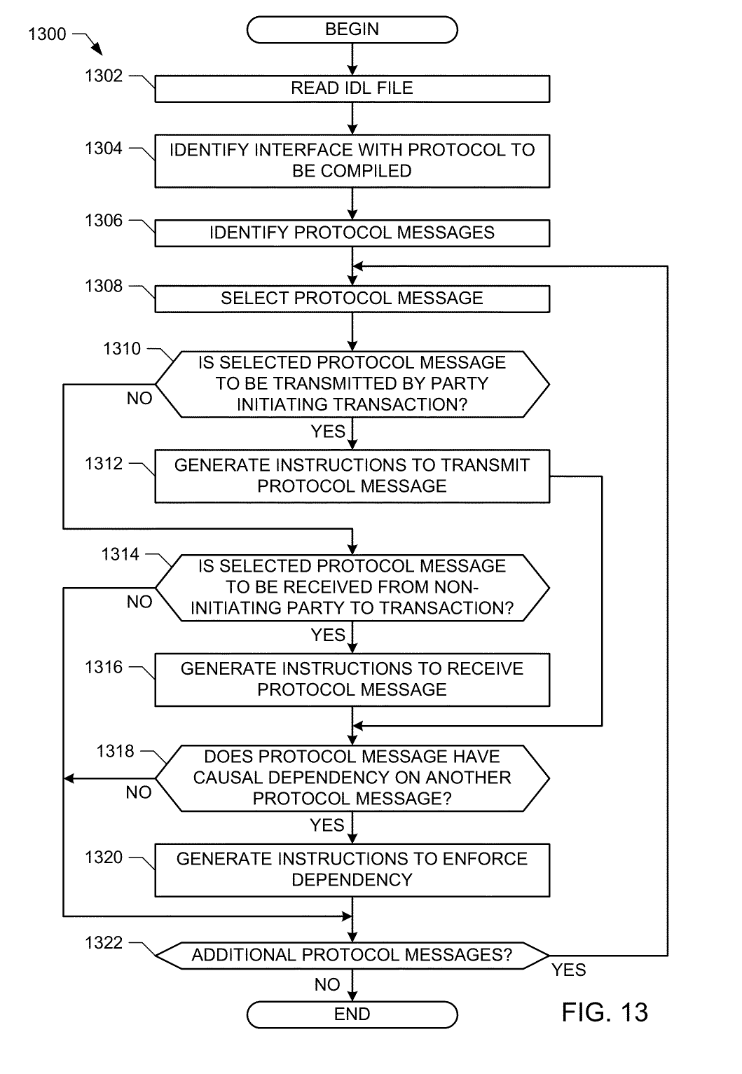

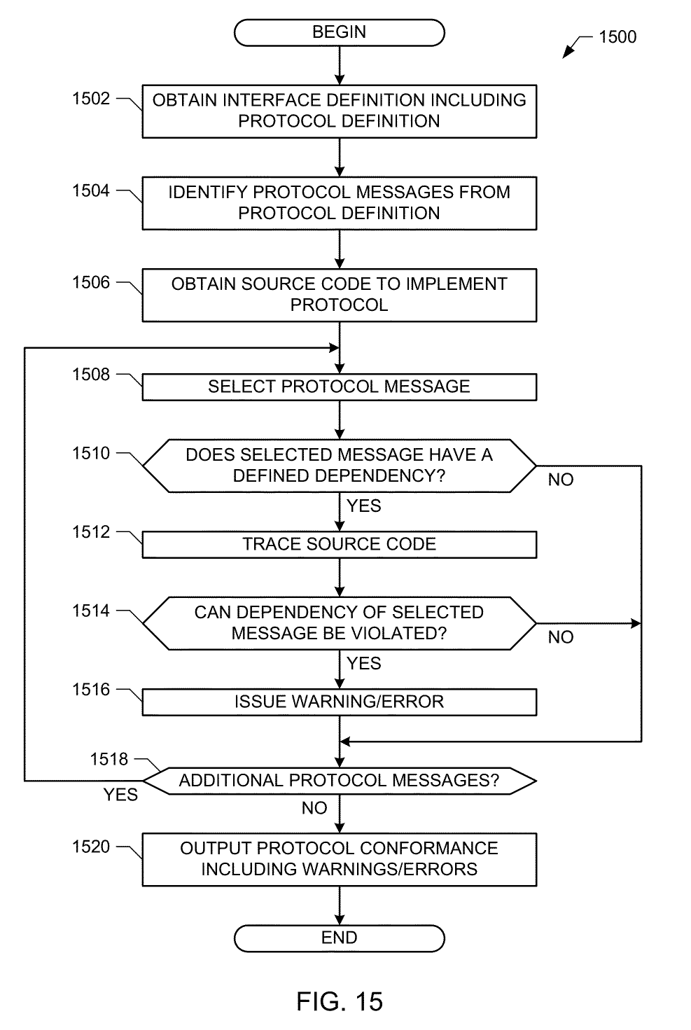

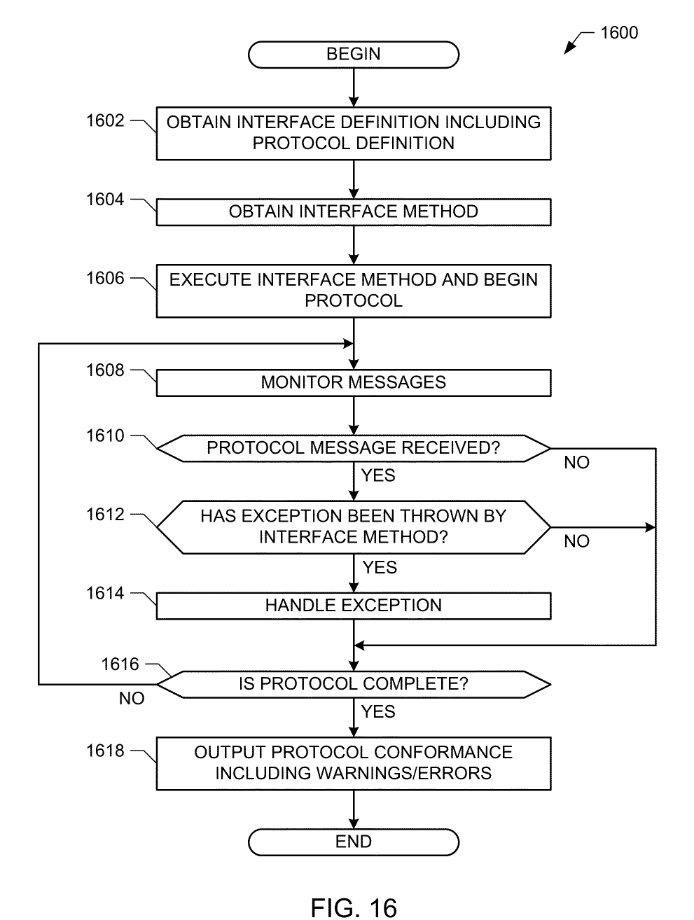

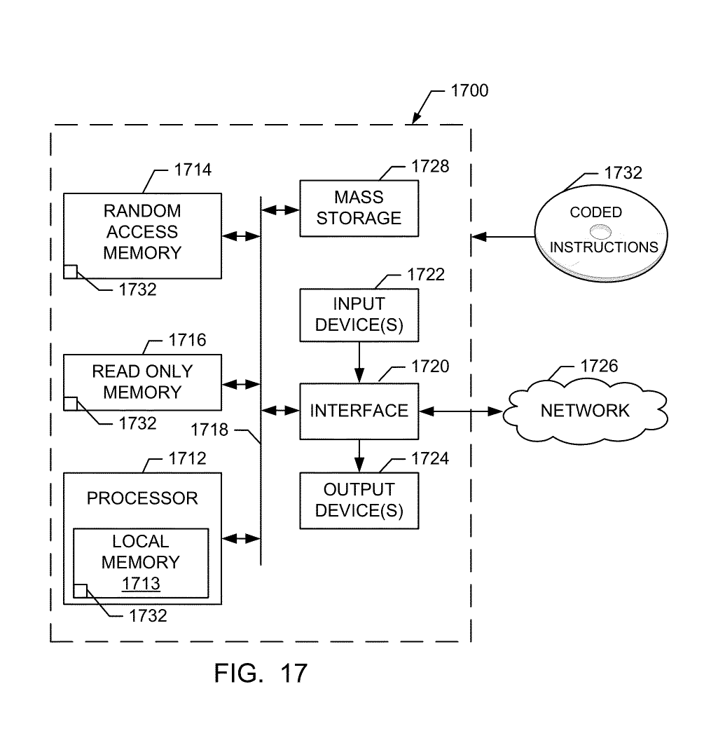

Flowcharts representative of example machine readable instructions for implementing the interface generator 206 of FIGS. 2 and/or 3 are shown in FIGS. 13 and/or 14. A flowchart representative of example machine readable instructions for implementing the protocol conformance determiner 402 of FIG. 4 is shown in FIG. 15. A flowchart representative of example machine readable instructions for implementing the message runtime 102 of FIG. 1 is shown in FIG. 16. In these examples, the machine readable instructions comprise program(s) for execution by a processor such as the processor 1712 shown in the example processing platform 1700 discussed below in connection with FIG. 17. The program may be embodied in software stored on a tangible computer readable medium such as a CD-ROM, a floppy disk, a hard drive, a digital versatile disk (DVD), a Blu-ray disk, or a memory associated with the processor 1712, but the entire program and/or parts thereof could alternatively be executed by a device other than the processor 1712 and/or embodied in firmware or dedicated hardware. Further, although the example program is described with reference to the flowcharts illustrated in FIGS. 13-16, many other methods of implementing the example interface generator 206 and/or the example protocol conformance determiner 402 may alternatively be used. For example, the order of execution of the blocks may be changed, and/or some of the blocks described may be changed, eliminated, or combined.

As mentioned above, the example processes of FIGS. 13-16 may be implemented using coded instructions (e.g., computer readable instructions) stored on a tangible computer readable storage medium such as a storage drive, a storage disc, a hard disk drive, a flash memory, a read-only memory (ROM), a compact disk (CD), a digital versatile disk (DVD), a Blu-ray disc, a cache, a random-access memory (RAM) and/or any other storage medium in which information is stored for any duration (e.g., for extended time periods, permanently, brief instances, for temporarily buffering, and/or for caching of the information). As used herein, the term tangible computer readable storage medium is expressly defined to include any type of computer readable storage device and/or storage disc and to exclude propagating signals. Additionally or alternatively, the example processes of FIGS. 13-16 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable storage device and/or storage disc irrespective of the duration of storage and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

FIG. 13 is a flowchart representative of example machine readable instructions 1300 to implement the example interface generator 206 of FIGS. 2 and/or 3 to generate an initiating party interface stub (e.g., the initiating party interface stub 310 of FIG. 3).

The example interface generator 206 of FIG. 3 reads an interface definition language file (block 1302). For example, the interface generator 206 may read (e.g., parse) the interface definition 208 of FIG. 3. The interface generator 206 identifies an interface (e.g., the interface definition 208) having a protocol to be compiled (e.g., the protocol definition 306 of FIG. 3) (block 1304). In the example of FIG. 13, the protocol is a first-class protocol (e.g., a protocol as a first-class object, entity, or citizen). The example interface generator 206 (e.g., via the initiating party stub generator 304) identifies protocol messages in the protocol definition 306 (block 1306).

The initiating party stub generator 304 selects a protocol message (block 1308). For example, the initiating party stub generator 304 may select the message 602 or the message 604 from the instructions 600 of FIG. 6. The example initiating party stub generator 304 determines whether the selected protocol message 602 is to be transmitted by a party or device initiating the transaction (block 1310). The initiating party stub generator 304 may determine which party is to transmit the messages 602, 604 by identifying a role statement (e.g., @client, @server, @source(source), etc.). If the selected protocol message is to be transmitted by a party initiating the transaction (e.g., a client), the example initiating party stub generator 304 generates instructions to transmit the protocol message (block 1312). For example, the initiating party stub generator 304 may generate instructions to transmit the protocol message 602 based on a @client statement but does not generate instructions to transmit the protocol message 604 based on a @server statement.

If the example selected protocol message is not to be transmitted by an initiating party (block 1310), the example initiating party stub generator 304 determines whether the selected protocol message is to be received from a non-initiating party to a transaction (block 1314). For example, the initiating party stub generator 304 may determine whether the initiating party is to receive a protocol message by identifying that the message in included two-party protocol and is not transmitted by the initiating party (e.g., a @server message), or that the message has a designated target device (e.g., the message includes an @target(device) statement). If the selected protocol message is to be received from a non-initiating party (block 1314), the example initiating party stub generator 304 generates instructions to receive the selected protocol message (block 1316). For example, the initiating party stub generator 304 may generate instructions to receive the protocol message 604 based on a @server statement.

After generating instructions to transmit (block 1312) or receive (block 1316) the selected protocol message, the example initiating party stub generator 304 determines whether the selected protocol message has a causal dependency on another protocol message (block 1318). For example, the initiating party stub generator 304 may identify a dependency statement such as @next that specifies that the protocol statement is to follow or be followed by another protocol message. If the selected protocol message has a dependency (block 1318), the example initiating party stub generator 304 generates instructions to enforce the dependency (block 1320). For example, the initiating party stub generator 304 may generate an if-then or other branching instruction to make the transmission or receipt of the selected protocol message dependent on a condition such as the transmission or receipt of the message on which the selected message is dependent according to the protocol definition 306.

After generating the instructions to enforce the dependency (block 1320), if there is no defined dependency (block 1318), or if the selected protocol message is to not be either transmitted (block 1310) or received (block 1314) by the initiating party the example initiating party stub generator 304 determine whether there are additional protocol messages (block 1322). If there are additional messages (block 1322), control returns to block 1308 to select another protocol message. If there are no more protocol messages in the protocol (block 1322), the example instructions 1300 may end. In some examples, the instructions 1300 may iterate to generate instructions for additional protocols in the IDL file.

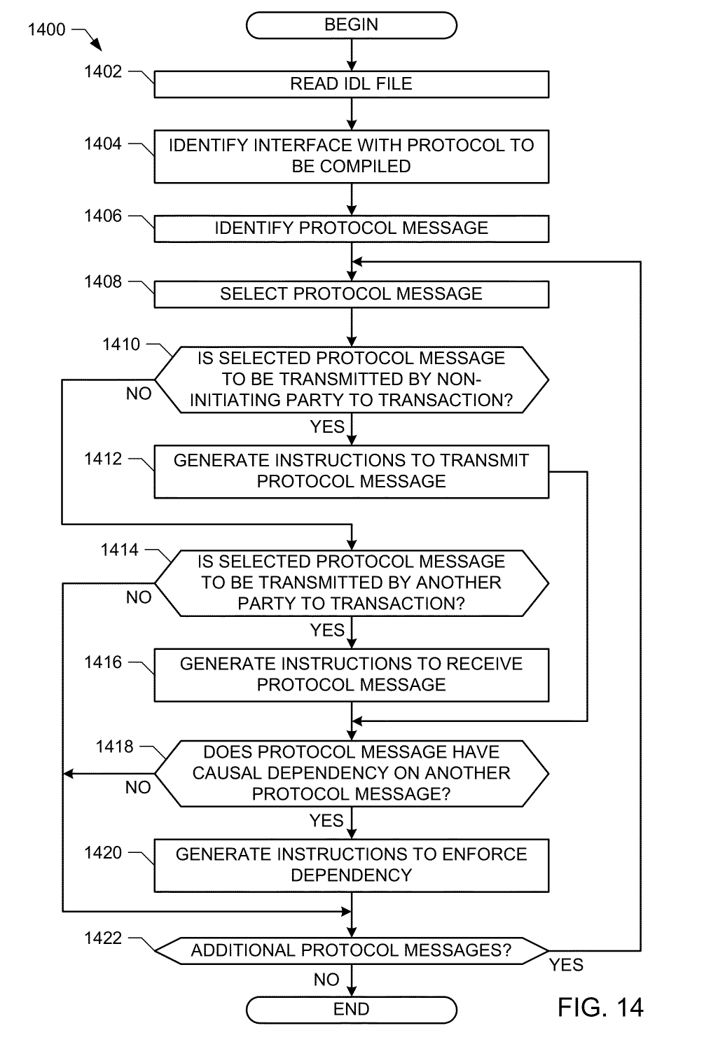

FIG. 14 is a flowchart representative of example machine readable instructions 1400 to implement the example interface generator of FIGS. 2 and/or 3 to generate a non-initiating party interface stub (e.g., the non-initiating party interface stub 308 of FIG. 3).

The example interface generator 206 of FIG. 3 reads an interface definition language file (block 1402). For example, the interface generator 206 may read (e.g., parse) the interface definition 208 of FIG. 3. The interface generator 206 identifies an interface (e.g., the interface definition 208) having a protocol to be compiled (e.g., the protocol definition 306 of FIG. 3) (block 1404). In the example of FIG. 14, the protocol is a first-class protocol (e.g., a protocol as a first-class object, entity, or citizen). The example interface generator 206 (e.g., via the non-initiating party stub generator 302) identifies protocol messages in the protocol definition 306 (block 1406).

The non-initiating party stub generator 302 selects a protocol message (block 1408). For example, the non-initiating party stub generator 302 may select the message 602 or the message 604 from the instructions 600 of FIG. 6. The example non-initiating party stub generator 302 determines whether the selected protocol message 602 is to be transmitted by a party or device not initiating the transaction (block 1410). The non-initiating party stub generator 302 may determine which party is to transmit the messages 602, 604 by identifying a role statement (e.g., @client, @server, @source(source), etc.). If the selected protocol message is to be transmitted by a non-initiating party to the transaction (e.g., a client), the example non-initiating party stub generator 302 generates instructions to transmit the protocol message (block 1412). For example, the initiating party stub generator 304 may generate instructions to transmit the protocol message 604 based on a @server statement but does not generate instructions to transmit the protocol message 602 based on a @client statement. In some examples, the non-initiating party stub generator 302 determines whether the selected protocol message is to be transmitted by a selected non-initiating party by determining a role (e.g., a @role(entity) statement, a @source(entity) statement) of the protocol message and, based on the role, selectively generating instructions to transmit the protocol message.

If the example selected protocol message is not to be transmitted by a non-initiating party (block 1410), the example non-initiating party stub generator 302 determines whether the selected protocol message is to be received from another party to a transaction (e.g., an initiating party, another non-initiating party) (block 1414). For example, the non-initiating party stub generator 302 may determine whether the non-initiating party is to receive a protocol message by identifying that the message in included two-party protocol and is not transmitted by the non-initiating party (e.g., a @client message), or that the message has a designated target device (e.g., the message includes an @target(device) statement). If the selected protocol message is to be received from another party (block 1414), the example non-initiating party stub generator 302 generates instructions to receive the selected protocol message (block 1416). For example, the non-initiating party stub generator 302 may generate instructions to receive the protocol message 602 based on a @client statement.

After generating instructions to transmit (block 1412) or receive (block 1416) the selected protocol message, the example initiating party stub generator 304 determines whether the selected protocol message has a causal dependency on another protocol message (block 1418). For example, the initiating party stub generator 304 may identify a dependency statement such as @next that specifies that the protocol statement is to follow or be followed by another protocol message. If the selected protocol message has a dependency (block 1418), the example non-initiating party stub generator 302 generates instructions to enforce the dependency (block 1420). For example, the non-initiating party stub generator 302 may generate an if-then or other branching instruction to make the transmission or receipt of the selected protocol message dependent on a condition such as the transmission or receipt of the message on which the selected message is dependent according to the protocol definition 306.

After generating the instructions to enforce the dependency (block 1420), if there is no defined dependency (block 1418), or if the selected protocol message is to not be either transmitted (block 1410) or received (block 1414) by the non-initiating party, the example non-initiating party stub generator 302 determine whether there are additional protocol messages (block 1422). If there are additional messages (block 1422), control returns to block 1408 to select another protocol message. If there are no more protocol messages in the protocol (block 1422), the example instructions 1400 may end. In some examples, the instructions 1400 may iterate to generate instructions for additional protocols in the IDL file.

FIG. 15 is a flowchart representative of example machine readable instructions 1500 to implement the example protocol conformance determiner 402 of FIG. 4 to determine conformance of an interface method with an interface definition. The example instructions 1500 of FIG. 15 use static analysis of an interface method to determine conformance.

The example protocol conformance determiner 402 of FIG. 4 obtains an interface definition (e.g., the interface definition 208 of FIG. 4) including a protocol definition (e.g., the protocol definition(s) 306 of FIG. 4) (block 1502). The example protocol conformance determiner 402 identifies protocol messages from the protocol definition 306 (block 1504). In the example of FIG. 15, the protocol definition 306 includes a first-class protocol. The example protocol conformance determiner 402 obtains source code to implement the protocol (e.g., the non-initiating party source code 404, the initiating party source code 406 of FIG. 4) (block 1506).

The protocol conformance determiner 402 selects a protocol message (e.g., from the protocol definition 306) (block 1508). For example, the protocol conformance determiner 402 may select a message 702-706 from the instructions 700 of FIG. 7. The example protocol conformance determiner 402 determines whether the selected message 702-706 has a defined dependency (block 1510). For example, the protocol conformance determiner 402 may identify a @next(message) statement in the selected message 702-706 to identify a dependency.

If the selected message has a defined dependency (block 1510), the example protocol conformance determiner 402 traces the source code 404, 406 (block 1512). For example, the protocol conformance determiner 402 may execute or simulate execution for a set of inputs to determine the results of the source code 404, 406. The protocol conformance determiner 402 determines whether the dependency of the selected message can be violated (block 1514). For example, the protocol conformance determiner 402 may determine whether the selected message can be executed prior to the message on which it depends in violation of the dependency defined in the protocol definition 306. If the dependency can be violated (block 1514), the example protocol conformance determiner 402 issues a warning or error (block 1516). For example, the protocol conformance determiner 402 may issue an error if there is greater than a threshold likelihood based on the test inputs that the dependency will be violated by the source code 404, 406, and issue a warning if there is less than a threshold likelihood but at least some likelihood that the dependency will be violated.

After issuing the warning or error (block 1516), if the dependency of the selected message will not be violated (block 1514), or if the selected message has no defined dependency (block 1510), the example protocol conformance determiner 402 determines whether the protocol definition has additional protocol messages (block 1518). If there are additional protocol messages (block 1518), control returns to block 1508 to select another protocol message. If there are no more protocol messages (block 1518), the example protocol conformance determiner 402 outputs the protocol conformance including the warnings and/or errors (block 1520). The example instructions 1500 may then end and/or iterate to determine the conformance of additional source code 404, 406 to the same or different protocol definitions.

FIG. 16 is a flowchart representative of example machine readable instructions 1600 to implement the example message runtime 102 of FIG. 1 to determine conformance of an interface method with an interface definition, including a protocol definition, during runtime.

The example message runtime 102 obtains an interface definition (e.g., the interface definition 208, 500, 800 of FIGS. 2-5 and/or 8) including a protocol definition (e.g., the protocol definition 306, 600, 700, 804, 1200 of FIGS. 3-4, 6-8, and/or 12) (block 1602). In some examples, the protocol definition 306 defines a first-class protocol. The example message runtime 102 obtains an interface method (block 1604). For example, the message runtime 102 may obtain the non-initiating party interface method 312 and/or the initiating party interface method 314 of FIGS. 3-4. The example message runtime 102 executes the interface method 312, 314 and begins a protocol implemented by the interface method 312, 314 (block 1606).

The example message runtime 102 monitors messages transmitted to and/or from the device or party associated with the interface method 312, 314 (block 1608). For example, the message runtime 102 may monitor messages transmitted by the initiating device 202 and/or received by the initiating device 202 of FIG. 2. The example message runtime 102 determines whether a protocol message has been received (block 1610). If a protocol message is received (block 1610), the example message runtime 102 determines whether an exception has been thrown by the interface method 312, 314 (block 1612). For example, the instructions 1022-1026 of FIGS. 10A-10B may throw an exception in response to a received protocol message that breaks the protocol.

The exception(s) identified in FIG. 16 represent the identification of the received protocol message being received out of order according to the protocol. For example, the message runtime 102 of FIGS. 1 and/or 3 may compare the received protocol message to one or more @next( )statements defined in the protocol definition 306. If a previous message corresponds to an @next( )statement and the received protocol message is different from the another message specified as being the next message, the example message runtime 102 may throw an exception identifying the break in the protocol. In some other examples, the message runtime 102 may determine whether a message has been sent and/or received out of order according to the protocol, and/or whether some other type of error or warning has occurred in response to the message.

If an exception has been thrown (e.g., the message has been received out of order according to the protocol, or otherwise breaks the protocol) (block 1612), the example message runtime 102 handles the exception (block 1614). For example, the message runtime 102 may execute an exception handling routine to correct the protocol and/or may end the protocol in response to the exception. After handling the exception (block 1614), if there is no exception thrown (e.g., the received protocol message complies with the message ordering defined in the protocol) (block 1612), or if no protocol messages have been received (block 1610), the example message runtime 102 determines whether the protocol is complete (block 1616).

If the protocol is not complete (block 1616), control returns to block 1608 to continue monitoring messages. If the protocol is complete (block 1616), the example message runtime 102 outputs the protocol conformance including any warnings, errors, and/or exceptions resulting from the interface method 312, 314 and/or from execution of the protocol (block 1618). The example instructions 1600 of FIG. 16 may then end and/or iterate to determine the runtime protocol conformance of additional interface methods.

FIG. 17 is a block diagram of an example processing platform 1700 capable of executing the instructions of FIGS. 13-16 to implement the non-initiating party stub generator 302, the initiating party stub generator 304 and/or, more generally, the interface generator 206 and/or the protocol conformance determiner 402 of FIGS. 2-4. The processing platform 1700 can be, for example, a server, a personal computer, a mobile phone (e.g., a cell phone, a smart phone), a personal digital assistant (PDA), a tablet computer, or any other type of computing device.

The processing platform 1700 of the instant example includes a processor 1712. For example, the processor 1712 can be implemented by one or more microprocessors or controllers from any desired family or manufacturer.

The processor 1712 includes a local memory 1713 (e.g., a cache) and is in communication with a main memory including a volatile memory 1714 and a non-volatile memory 1716 via a bus 1718. The volatile memory 1714 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1716 may be implemented by flash memory and/or any other desired type of memory device. Access to the main memory 1714, 1716 is controlled by a memory controller.

The processing platform 1700 also includes an interface circuit 1720. The interface circuit 1720 may be implemented by any type of interface standard, such as an Ethernet interface, a universal serial bus (USB), and/or a PCI express interface.

One or more input devices 1722 are connected to the interface circuit 1720. The input device(s) 1722 permit a user to enter data and commands into the processor 1712. The input device(s) can be implemented by, for example, a keyboard, a mouse, a touchscreen, a track-pad, a trackball, isopoint and/or a voice recognition system.

One or more output devices 1724 are also connected to the interface circuit 1720. The output devices 1724 can be implemented, for example, by display devices (e.g., a liquid crystal display, a cathode ray tube display (CRT), a printer and/or speakers). The interface circuit 1720, thus, typically includes a graphics driver card.

The interface circuit 1720 also includes a communication device such as a modem or network interface card to facilitate exchange of data with external computers via a network 1726 (e.g., an Ethernet connection, a digital subscriber line (DSL), a telephone line, coaxial cable, a cellular telephone system, etc.).

The processing platform 1700 also includes one or more mass storage devices 1728 for storing software and data. Examples of such mass storage devices 1728 include floppy disk drives, hard drive disks, compact disk drives and digital versatile disk (DVD) drives.

The coded instructions 600-1000, 1200-1600, and/or 1732 of FIGS. 6-10B, 12-16, and/or 17 may be stored in the mass storage device 1728, in the volatile memory 1714, in the non-volatile memory 1716, and/or on a removable storage medium such as a CD or DVD.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A method, comprising:
generating, using a processor, first computer readable instructions to specify a message to be transmitted by a non-initiating device of a transaction for delivery to a second device based on a protocol; and
storing, in a storage device, second computer readable instructions to implement the protocol, the second computer readable instructions including the first computer readable instructions.

2. A method as defined in claim 1, wherein the protocol comprises a first-class object.

3. A method as defined in claim 1, wherein generating the second computer readable instructions comprises specifying an argument to be sent to the second device.

4. A method as defined in claim 1, further comprising generating third computer readable instructions to specify a second message to be transmitted by the second device based on the protocol.

5. A method as defined in claim 1, wherein the first computer readable instructions are to enable the non-initiating device to transmit the message to the second device without receiving a request for which the message is a response.

6. A method as defined in claim 1, wherein the first computer readable instructions are further to specify a second message based on the protocol that is to be transmitted by the non-initiating device or the second device prior to the message being transmitted.

7. A method as defined in claim 1, further comprising reading an interface definition file, wherein generating the first computer readable instructions is based on the interface definition file.

8. A method as defined in claim 7, wherein the first computer readable instructions are based on a statement in the interface definition file that defines the non-initiating party as a source of the message and the second device as a target of the message.

9. A method as defined in claim 1, further comprising generating third computer readable instructions to cause the non-initiating device to transmit the message to the second device via a message queue.

10. An apparatus, comprising:
a processor; and
a memory comprising first computer readable instructions which, when executed, cause a processor to:
generate second computer readable instructions to specify a message to be transmitted by a non-initiating device of a transaction for delivery to a second device based on a protocol; and
store, in the memory, third computer readable instructions to implement the protocol, the third computer readable instructions including the second computer readable instructions.

11. An apparatus as defined in claim 10, wherein the protocol comprises a first-class object.

12. An apparatus as defined in claim 10, wherein the instructions are to cause the processor to generate the second computer readable instructions by specifying an argument to be sent to the second device.

13. An apparatus as defined in claim 10, wherein the instructions are further to cause the processor to generate fourth computer readable instructions to specify a second message to be transmitted by the second device based on the protocol.

14. An apparatus as defined in claim 10, wherein the second computer readable instructions are to enable the non-initiating device to transmit the message to the second device without receiving a request for which the message is a response.

15. An apparatus as defined in claim 10, wherein the second computer readable instructions are further to specify a second message based on the protocol that is to be transmitted by the non-initiating device or the second device prior to the message being transmitted.

16. An apparatus as defined in claim 10, wherein the instructions are further to cause the processor to read an interface definition file, wherein generating the first computer readable instructions is based on the interface definition file.

17. An apparatus as defined in claim 16, wherein the second computer readable instructions are based on a statement in the interface definition file that defines the non-initiating device as a source of the message and the second device as a target of the message.

18. An apparatus as defined in claim 10, wherein the instructions are further to cause the processor to generate fourth computer readable instructions to cause the non-initiating device to transmit the message to the second device via a message queue.

19. A tangible computer readable storage medium comprising first computer readable instructions which, when executed, cause a processor to at least:
generate second computer readable instructions to specify a message to be transmitted by a non-initiating device of a transaction for delivery to a second device based on a protocol; and
store third computer readable instructions to implement the protocol, the third computer readable instructions including the second computer readable instructions.

20. A storage medium as defined in claim 19, wherein the protocol comprises a first-class object.

21. A storage medium as defined in claim 19, wherein the instructions are to cause the processor to generate the second computer readable instructions by specifying an argument to be sent to the second device.

22. A storage medium as defined in claim 19, wherein the instructions are further to cause the processor to generate fourth computer readable instructions to specify a second message to be transmitted by the second device based on the protocol.

23. A storage medium as defined in claim 19, wherein the second computer readable instructions are to enable the non-initiating device to transmit the message to the second device without receiving a request for which the message is a response.

24. A storage medium as defined in claim 19, wherein the second computer readable instructions are further to specify a second message based on the protocol that is to be transmitted by the non-initiating device or the second device prior to the message being transmitted.

25. A storage medium as defined in claim 19, wherein the instructions are further to cause the processor to read an interface definition file, wherein generating the first computer readable instructions is based on the interface definition file.

26. A storage medium as defined in claim 25, wherein the second computer readable instructions are based on a statement in the interface definition file that defines the non-initiating party as a source of the message and the second device as a target of the message.

27. A storage medium as defined in claim 19, wherein the instructions are further to cause the processor to generate fourth computer readable instructions to cause the non-initiating device to transmit the message to the second device via a message queue.

28. An apparatus, comprising:
a storage device; and
a non-initiating party stub generator to:
generate first computer readable instructions to specify a message to be transmitted by a non-initiating device of a transaction for delivery to a second device based on a protocol; and
store, in the storage device, second computer readable instructions to implement the protocol, the second computer readable instructions including the first computer readable instructions.

29. An apparatus as defined in claim 28, further comprising an initiating party stub generator to generate third computer readable instructions to specify a second message to be transmitted by the second device based on the protocol.

30. An apparatus as defined in claim 28, wherein the non-initiating party stub generator is to generate the first instructions to enable the non-initiating device to transmit the message to the second device without receiving a request for which the message is a response.
